(19) United States
(12) Patent Application Publication
(10) Pub. No.: US 2011/0191134 A1
(43) Pub. Date: Aug. 4, 2011

(54) CONTACT OFFER TIME FOR AGENTS SUPPORTING CONTACT CENTERS

(76) Inventors: Mukul Jain, San Jose, CA (US); Raghurama Bhat, Cupertino, CA (US); Joseph F. Khouri, San Jose, CA (US)

(21) Appl. No.: 12/699,675

(22) Filed: Feb. 3, 2010

(51) Int. Cl. G06Q 10/00; G06Q 99/00

(52) U.S. Cl. 705/7.13; 705/304

(57) ABSTRACT

A method for assisting an agent supporting a contact center is provided. The method includes obtaining one or more contact offer factors, determining a contact offer time for the agent supporting the contact center based on the one or more contact offer factors, and providing the contact offer time to the agent. The contact offer time defines when the agent will receive a contact offer.

### FIELD

The present embodiments relate generally to contact centers.

### BACKGROUND

Contact centers are used to manage communication, such as calls, email, chat messages, faxes, and instant messages. Management of communication may include receiving communication from a contact and intelligently routing the communication to an agent supporting the contact center. As used herein, the term “supporting the contact center” includes available to receive or respond to communication. For a variety of reasons, contacts may be required to wait until an agent becomes available. Accordingly, contact centers are configured to provide the contact with a service wait time. The service wait time may be the estimated amount of time before an agent is available to communicate with the contact.

### BRIEF DESCRIPTION OF THE DRAWINGS

FIG. 1 illustrates one embodiment of a contact center system including one or more contacts, a contact center, and one or more agents;

FIG. 2 illustrates one embodiment of the interaction between a contact center, a contact, and an agent;

FIG. 3 illustrates one embodiment of a contact center that is operable to determine a contact offer time for an agent supporting the contact center;

FIG. 4A illustrates one embodiment of a contact offer time, and FIG. 4B illustrates another embodiment of a contact offer time;

FIG. 5 illustrates one embodiment of a method for managing communication; and

FIG. 6 illustrates one embodiment of a method for determining a contact offer time.

### DETAILED DESCRIPTION

### General Overview

In one embodiment, a contact center system includes a contact center that is operable, configured and/or programmed to determine a contact offer time for an agent supporting the contact center. The contact offer time may be an estimation and/or calculation of the time remaining before the agent receives a contact offer. The contact offer time may be a time value (e.g., 10 minutes) or a relative position value (e.g., 2^{nd} in queue). Furthermore, the contact offer may be a request, offer, instruction, or command to receive or respond to communication. For example, the contact offer may be a request to assist or communicate with a contact via a telephone. The contact offer may be broadcast to one or more agents. The contact offer time is the amount of time before a given agent will receive the next contact offer. The contact center may provide the contact offer time to the agent, for example, via an agent device being used by the agent. The estimation or calculation may be determined using a contact offer model.

One benefit of the contact offer time is that an agent may use the contact offer time to plan or schedule activities, tasks, or duties. For example, an agent may delay a break or reschedule a meeting in the event that the contact offer time indicates that the specific agent is about to receive a contact offer. Ensuring that the agent is available to interact with the contact provides a better experience for the contact that ultimately increases customer satisfaction.

### DESCRIPTION

The present embodiments relate to determining a contact offer time for an agent. The contact offer time may define when the agent will receive a contact offer. For example, in one embodiment, a contact center system may include a contact device, an agent device, and a contact center. The contact device may be operated by a contact and the agent device may be operated by an agent supporting the contact center. The contact center may be configured to determine a contact offer time for the agent based on one or more contact offer factors, which may include information about a contact, a contact queue, an agent queue, the agent, or any combination thereof. The contact center may output the contact offer time to the agent.

In one aspect, a method for assisting an agent supporting a contact center is provided. The method includes obtaining one or more contact offer factors; determining a contact offer time for the agent supporting the contact center based on the one or more contact offer factors, the contact offer time defining when the agent will receive a contact offer; and providing the contact offer time to the agent.

In a second aspect, a system for assisting an agent supporting a contact center is provided. The system includes a processor and an output device coupled with the processor. The processor is operable to obtain one or more contact offer factors and determine a contact offer time for the agent supporting the contact center based on the one or more contact offer factors. The contact offer time defines when the agent will receive a contact offer. The output device is operable to provide the contact offer time to the agent.

In a third aspect, logic encoded in one or more tangible media is provided. The logic is executable by a processor and is operable to obtain one or more contact offer factors; determine a contact offer time for the agent supporting the contact center based on the one or more contact offer factors, the contact offer time defining when the agent will receive a contact offer; and provide the contact offer time to the agent.

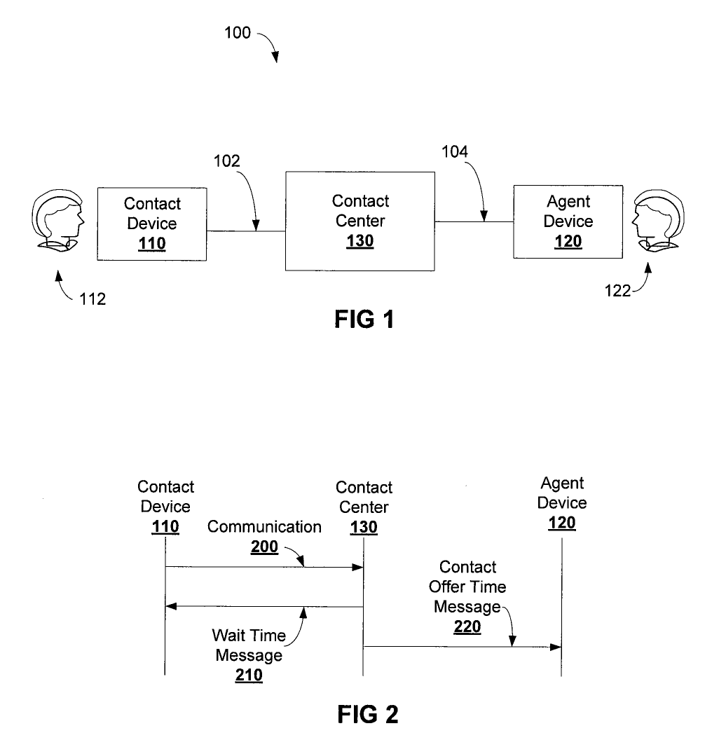

FIG. 1 illustrates one embodiment of a contact center system 100. The contact center system 100 may include one or more contact devices (hereinafter, “contact device”) 110, one or more agent devices (hereinafter, “agent device”) 120, and a contact center 130. The contact center 130 may be coupled with the contact device 110 via a network 102 and with the agent device 130 via a network 104. As used herein, the term “coupled with” may include directly connected with or indirectly connected through one or more intermediary components. Intermediary components may include networks, hardware components, software components, or any combination thereof. The contact center system 100 may include additional, different, or fewer components.

The networks 102 and 104 may be telecommunication networks, wireless networks, wired networks, radio networks, Internet networks, intranet networks, Transmission Control Protocol (TCP)/Internet Protocol (IP) networks, Ethernet networks, packet-based networks, fiber optic network, telephone network, cellular networks, computer networks, public switched telephone networks, or any other now known or later developed networks. Exemplary telecommunication networks may include wide area networks, local area networks, virtual private networks, peer-to-peer networks, and wireless local area networks. The network 102 may be the same or different than network 104. In one embodiment, the network 102 is a telephone network and the network 104 is a packet-based network, such as an Ethernet network. The networks 102 and 104 may be operable to transmit messages, communication, information, or other data to and/or from the contact center 130.

The contact device 110 may be owned, operated, managed, controlled, programmed, or otherwise used by a contact 112. The contact 112 may be a human or electrical device (e.g., including a processor and/or memory) configured to use the contact device 110. The contact device 110 may be a public switched telephone, cellular telephone, personal computer, personal digital assistant, mobile device, or other device that is operable to communicate via network 102. The contact device 110 may be operable to communicate with the agent device 120 and/or contact center 130.

The agent device 120 may be owned, operated, managed, controlled, programmed, or otherwise used by an agent 122 or administrator of the contact center 130. Agents 122 may be humans or electronic (e.g., including a processor and/or memory) devices configured to interact with the contact 112. Exemplary electronic devices include interactive voice response systems, routing systems, or other contact treatment systems. The agent device 120 may be a telephone, cellular telephone, personal computer, server, personal digital assistant, mobile device, or other device that is operable to communicate via network 104. The agent device 120 may communicate with the contact device 110 and/or contact center 130.

The agent 122 may be a contact center agent, expert advisor, or other type of agent. Contact center agents regularly and/or only support the contact center 130. The primary responsibility (e.g., job) of a contact center agent is to receive, answer, or respond to contact center communication. For example, contact center agents may be agents that are hired to answer questions and are continuously or regularly communicating with contacts 112. Expert advisors may be available to support the contact center 130; however, do not regularly receive contact center communication.

In one illustration, the contact center 130 may be used by an income tax preparation service company (“tax company”). The tax company may employ one or more contact center agents that are responsible for answering basic questions related to the tax company, such as services provided by the tax company, technical difficulties, or other problems. The main responsibility of these contact center agents is to answer communication received by the contact center 130. The tax company may also use a tax expert, such as the chief financial officer of the tax company, to support the contact center 130. The tax expert has greater knowledge of the tax law than the contact center agents. The tax expert may be responsible for developing tax strategies, preparing tax appeals, and other complex tax matters. The primary responsibility of the tax expert is not to support the contact center 130. However, the tax expert may be available to support the contact center 130 when there is a complex issue that requires greater knowledge of the tax law than can be provided by the contact center agents.

The contact center 130 is operable to determine a service wait time, a contact offer time, or the combination thereof. The service wait time may be provided to the contact device 110 for indicating a length of wait before being connected to an agent device 120. The contact offer time may be provided to an agent device 120 for indicating a length of wait before being connected to a contact device 110.

The “service wait time” may be an amount of time that the contact 112 will wait before interacting with an agent 122 and/or a contact's position in a queue. For example, the wait time may be “2 minutes” or “3^{rd} contact in the queue.” The service wait time may be determined based on (i.e., as a function of or as a result of) the contact's position in a queue, the number or experience or skill of the agents 122 that are currently supporting the contact center 130, the average length of the interaction between a contact 112 and an agent 122, or other factors used to determine the service wait time. In one embodiment, the service wait time may include the time until an agent 122, for example, able to sufficiently support the contact 112, becomes available. Sufficiently supporting the contact 112 may include providing customer service that satisfies the contact 112. For example, in order to sufficiently support the contact 112, an agent 122 may need to have knowledge about a certain topic, issue, or inquiry. The service wait time for a first contact 112 may be the same or different than the wait time for a second contact 112.

The “contact offer time” may be an amount of time before the agent 122 is likely to receive a contact offer or be connected to a contact. The contact offer time may be a time value or a position relative to other agents. For example, the offer time may be “2 minutes” or “3^{rd} agent to receive a contact offer.” As discussed more below, the contact offer may be estimated and/or calculated. The contact offer time allows the agent 122 to determine how much time before a contact offer is received.

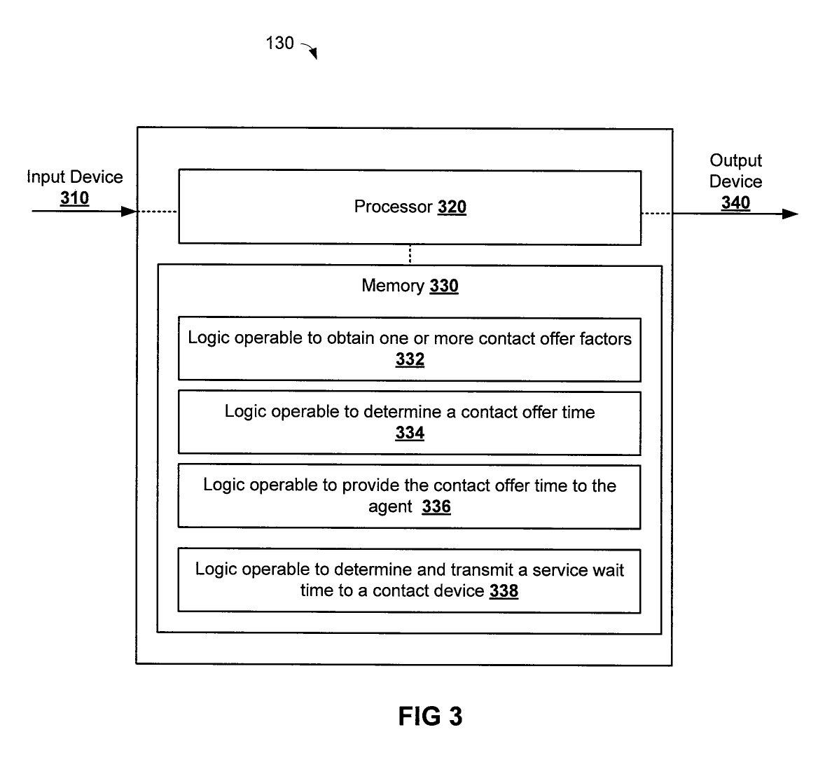

The contact center 130 may be operable to provide the service wait time to the contact 112, the contact offer time to the agent 122, or a combination thereof. For example, in one embodiment, as shown in FIG. 2, the contact center 130 may receive communication 200 from the contact device 110. The contact center 130 may determine a service wait time and transmit a service wait time message 210 to the contact device 110. The wait time message 200 may include the service wait time for the contact 112. The contact device 110 may receive the wait time message 200 and output the wait time. Output may include display a visual representation (e.g., text, video, or image), play audio, transmit over a wired or wireless network, store in a memory, or a combination thereof.

Before and/or after receiving the communication 200, the contact center 130 may determine a contact offer time. The contact center 130 may transmit a contact offer message 220 to the agent device 120. The contact offer message 210 may include the contact offer time for the agent 122. The agent device 120 may receive the contact offer message 210 and output the contact offer time.

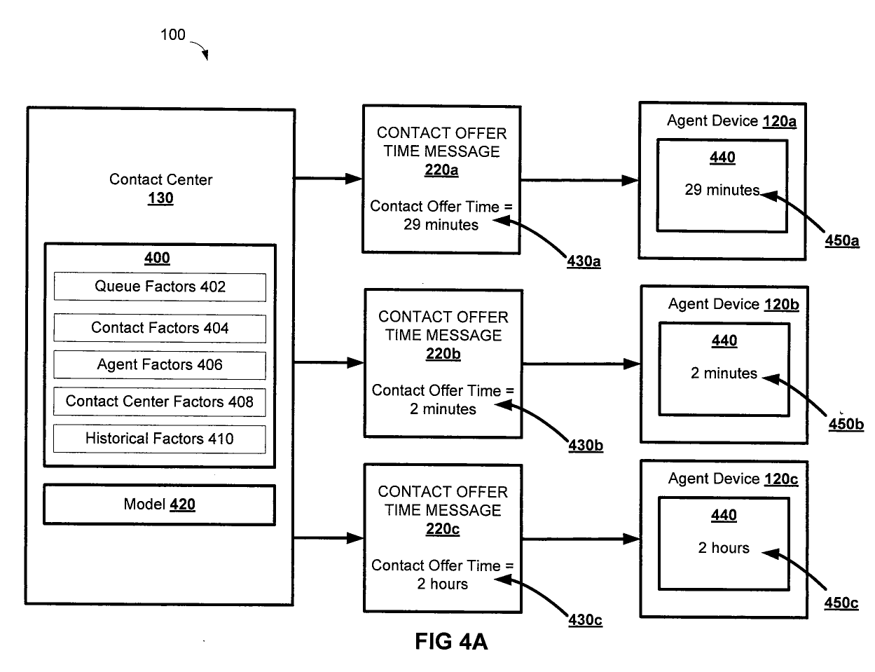

FIG. 3 illustrates one embodiment of the contact center 130. The contact center 130 may be a call center, queue manager, server, personal computer, customer interaction center, e-contact center, or other electronic device for managing (e.g., receiving, routing, storing, and/or processing) communication from a contact 112. In one embodiment, the contact center 130 is a call center having a queue manager. The queue manager may be an Internet Protocol (IP)-based, multisite call-treatment and routing solution that provides intelligent call-treatment options, such as call routing, computer telephony integration (CTI), and multimedia contact management over an IP network. The queue manager may provide static and/or dynamic call-treatment messages to queued callers and/or agents, whether the destinations are local or remote or are supported by an IP-based or time division multiplexing (TDM)-based automatic call distributor (ACD).

The contact center 130 may include an input device 310, a processor 320, a memory 330, and an output device 340. The contact center 130 may include additional, different, or fewer components.

The input device 310 may be a user input, network interface, external storage, other device for providing data to the contact center 130, or a combination thereof. Exemplary user inputs include mouse devices, keyboards, track balls, touch screens, joysticks, touch pads, buttons, knobs, sliders, combinations thereof, or other now known or later developed user input devices. The user input may operate as part of a user interface. For example, one or more buttons may be displayed on a display. The user input is used to control a pointer for selection and activation of the functions associated with the buttons. The input device 310 is a hard-wired or wireless network interface. For example, the input device 310 may be coupled with the networks 102 and 104 to receive data from the contact device 110 and/or agent device 120. A universal asynchronous receiver/transmitter (UART), a parallel digital interface, a software interface, Ethernet, or any combination of known or later developed software and hardware interfaces may be used. The network interface may be linked to various types of networks, including a local area network (LAN), a wide area network (WAN), an intranet, a virtual private network (VPN), and the Internet.

The input device 310 may be an interface to receive data. The data may be contact offer data. Contact offer data may include contact offer factors and relate to the contact device 110 (and/or contact 112), agent device 120 (and/or agent 122), contact center 130, or any combination thereof. As used herein, contact offer factors may include factors that may change, adjust, or otherwise impact the contact offer time. As discussed below, contact offer factors may be used to determine a contact offer time. Exemplary contact offer factors may include a contact's inquiry, complexity of a contact's inquiry, number of contact's in a contact center queue, the number of agent's supporting the contact center, the time, the date, incoming call volume, expected call arrival statistical pattern, how long before the given agent answered previous call, system statistics, agent's login/logout pattern, agent's likelihood of actively taking calls, how many queues does an agent support, how is the traffic pattern on each of those service queues, or other data that may be used to determine the contact offer time. Other contact offer factors may be used.

The processor 320 has any suitable architecture, such as a general processor, central processing unit, digital signal processor, application specific integrated circuit, field programmable gate array, digital circuit, analog circuit, combinations thereof, or any other now known or later developed device for processing data. Likewise, processing strategies may include multiprocessing, multitasking, parallel processing, and the like. A program may be uploaded to, and executed by, the processor 320. The processor 320 implements the program alone or includes multiple processors in a network or system for parallel or sequential processing.

The processor 320 is operable to obtain contact offer data. Obtaining contact offer data may include receiving from the input device 310, retrieving from memory 320, calculating, or otherwise determining or identifying contact offer data. For example, the processor 320 may use an interactive voice recognition system to request contact offer data from the contact 112. In another example, the processor 320 may calculate a frequency of an agent's acceptance of contact offers. In yet another example, the processor 320 may retrieve queue data from the memory 320. In one embodiment, the processor 320 is operable to process contact offer data to determine one or more contact offer factors.

The processor 320 is operable to determine a contact offer time based on (e.g., as a function of) contact offer factors. Determining the contact offer time may include calculating, computing, estimating, predicting, or otherwise obtaining a contact offer time. In one embodiment, for example, the contact offer time may be determined using a model.

The processor 320 creates a model, applies the model, or both creates and applies the model. The model may be a contact offer time model. A contact offer time model may be used to determine a contact offer time. The contact offer time model may be learned or derived from data for other agents, contact centers, and/or contacts. The processor 320 may apply the model or models. When applying the model, contact offer factors may be input into the model or models. The contact offer factors may be input according to requirements, such as inputting values in specific units. Alternatively, raw data is input and the model includes preprocessing to derive the values used by the model. Different inputs may be used for different models. For example, contact offer time may be predicted using a feature vector including number of contacts in a queue, length of interaction with a contact, and complexity of contact's inquiry. Missing data or factors may be substituted with an average, median, or default value. Alternatively, missing data may be left blank where the model may still provide sufficient accuracy.

In one embodiment, the model is a machine-learned model. For example, a model predicting contact offer time is machine trained. Any machine-learning algorithm or approach to classification may be used. For example, linear regression, heuristic analysis, weighting analysis, boosting network, Erlang process, linear discriminant analysis, relevance vector machine, Bayesian, combinations thereof, or other now known or later developed machine learning is provided. The machine learning provides a matrix or other output. The matrix is derived from analysis of a database of training data with known results, such as a database of data with binary or a larger range of possible labeled outcomes. The machine-learning algorithm determines the relationship of different inputs to the result. The learning may select only a sub-set of input features or may use all available input features. A programmer may influence or control which input features to use or other performance of the training. The matrix associates input features with outcomes, providing a model for classifying. Machine training provides relationships using one or more input variables with outcome, allowing for verification or creation of interrelationships not easily performed manually.

Alternatively, manually programmed models may be used. For example, a model predicting complete response is programmed. The model may be validated using machine training.

In response to the input, the contact offer time model outputs a contact offer time. The contact offer time may be an estimated time, estimated position, calculated time, calculated position, mathematical statistic, non-mathematical score, chance, likelihood, or a combination thereof. For example, in one embodiment, the contact offer time may include a 92% likelihood of receiving a contact offer in 5 minutes. In another embodiment, the contact offer time may include sets (e.g., a plurality) of contact offer times. The processor 320 may output the contact offer time to the memory 330, a display, over or to a network, to a printer, or in other media.

The processor 320 may update a contact offer factor database (or dataset). The database may include training information. For example, the processor 12 may update the training information to include the actual outcome of the time before the agent receives the contact offer. For example, the contact offer model may determine that the contact offer time for a first agent is 12 minutes; however, the first agent may receive a contact offer after 6 minutes. The contact offer time and/or the actual offer time may be stored.

In one example, for prediction of a contact offer time, the call arrival rate and availability of agents are modeled to a mathematical process, such as an Erlang process. The model may take into account how many agents are currently available and also predict how many agents will be available in a given amount of time. Heuristics, policies, and/or weighting may be taken into account to estimate a contact offer time for an agent.

The processor 320 may be operable to provide the contact offer time to the agent device 320, for example, using the output device 340. The output device 340 may be may be a user output, network interface, external storage, or other output device for providing data to the agent device 120. For example, the output device 340 may be a hard-wired or wireless network interface. The output device 340 is an interface to transmit data. The data may be contact offer data. The output device 340 may be coupled with the networks 102 and 104 to transmit data from the contact center 130 to a contact device 110 and/or agent device 120. A universal asynchronous receiver/transmitter (UART), a parallel digital interface, a software interface, Ethernet, or any combination of known or later developed software and hardware interfaces may be used. The network interface may be linked to various types of networks, including a local area network (LAN), a wide area network (WAN), an intranet, a virtual private network (VPN), and the Internet. In another embodiment, the output device 340 is a display device, such as a liquid crystal display device or light emitting diode device, which is operable to output a representation, such as an image, text, or graphic, of the contact offer time. In yet another embodiment, the output device 340 includes a speaker for outputting an audio representation of the contact offer time.

The memory 330 may be any now known or later discovered data storage device. The memory 118 and 120 may include a non-volatile and/or volatile memory, such as a random access memory (RAM), a read-only memory (ROM), an erasable programmable read-only memory (EPROM), or flash memory. The memory 330 may include an optical, magnetic (hard-drive) or any other form of data storage device. The memory 330 may be removable. For example, the memory 330 may be disposed in remote devices.

The processor 320 may be in communication with the memory 330. The processor 320 may also be in communication with additional components, such as the input device 310 and the output device 340. The memory 330 may store data, such as contact offer data or data used to determine a contact offer time for an agent supporting the contact center 130. The memory 330 may also store computer executable instructions. The processor 320 may be one or more devices operable to execute computer executable instructions. The computer executable instructions may be included in computer code. The computer code may be included in the memory 330. The computer code may be written in any computer language now known or later discovered, such as C++, C#, Java, Pascal, Visual Basic, Perl, HyperText Markup Language (HTML), JavaScript, assembly language, and any combination thereof. The computer code may be logic encoded in one or more tangible media for execution by the processor 320. Logic encoded in one or more tangible media for execution is defined as instructions that are executable by the processor 320 and that are provided on the computer-readable storage media, memories, or a combination thereof.

As shown in FIG. 3, the memory 330 may store logic for assisting an agent supporting a contact center. The logic may be executable by the processor 320 or a different processor. In one embodiment, the memory 330 may store logic operable to obtain one or more contact offer factors 332. The logic 332 may be executed to retrieve, receive, request, or identify the one or more contact offer factors. For example, the one or more contact offer factors may be received using an input device, retrieved from a memory, or requested using an output device. The logic 332 may be executed to process contact offer data, such that contact offer factors are determined. For example, the logic 332 may be executed to process time values to determine an average time value.

The memory 330 may store logic operable to determine a contact offer time for the agent supporting the contact center based on the one or more contact offer factors 334. The logic 334 may be executed to input the one or more contact offer factors into a contact offer model to predict when the agent will receive a contact offer. The logic 334 may be executed to calculate, estimate, predict, or otherwise determine the contact offer time.

The memory 330 may store logic operable to provide the contact offer time to the agent 336. The logic 336 may be executed to transmit the contact offer time to an agent device associated with the agent such that a contact offer time representation may be displayed on the agent device.

The memory 330 may store logic operable to determine and transmit a service wait time to a contact device 338. The service wait time may define an amount of time before the agent is available to communicate. The logic 338 may be executed to transmit a contact offer time message to the agent device and transmit the service wait time message to a contact device. The agent device may be the same or different than the contact device. Transmitting the contact offer time may include transmitting a contact offer time message including the contact offer time. Transmitting the service wait time may include transmitting a service wait time message including the service wait time. The contact offer time may be transmitted before, after, or both before and after the service wait time.

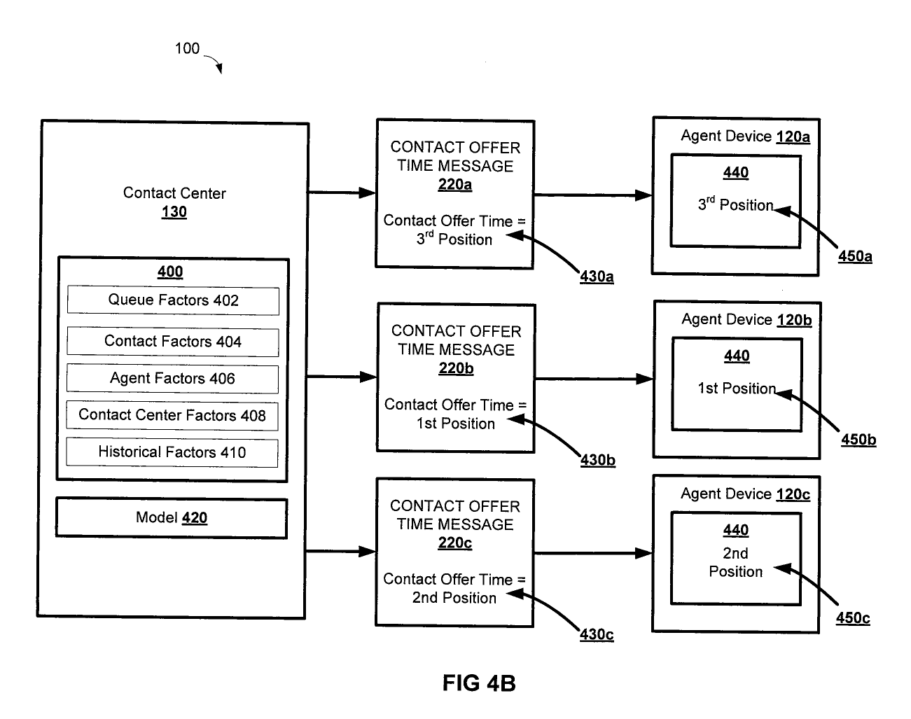

FIG. 4A illustrates one embodiment of a contact center system 100. The contact center 130 is operable to determine a contact offer time 430 for one or more agents 120. The contact center 130 may continuously or periodically determine a first contact offer time 430a for a first agent using a first agent device 120a, a second contact offer time 430b for a second agent using a second agent device 120b, and a third contact offer time 430c for a third agent using a third agent device 120c.

In order to determine the first, second, and third contact offer times 430a, 430b, 430c, the contact center 130 may create (or obtain) and/or apply a contact offer time model 420. Applying the contact offer time model 420 may include inputting one or more inputs 400, such as queue factors 402, contact factors 404, agent factors 406, contact center factors 408, and historical factors, into the model 420. The first, second, and third contact offer times 430a, 430b, 430c may be agent-specific. The contact center 130 may determine the contact offer times 430a, 430b, 430c at different times and use different factors. For example, the contact factors 404, which are used when determining the first contact offer time 430a, may be different than the contact factors 404 used when determining the second contact offer time 430b.

The contact offer time 430 may be a time value (e.g., 1 minute, 1 hour, etc.) and/or a position value (e.g., 3^{rd} position in a queue). FIG. 4A shows time values. As shown in FIG. 4A, the first contact offer time 430a may be 29 minutes, the second contact offer time 430b may be 2 hours, and the third contact offer time 430c may be 2 hours. FIG. 4B shows position values. As shown in FIG. 4B, the first contact offer time 430a may be a 3^{rd} position, the second contact offer time 430b may be a 1^{st} position, and the third contact offer time 430c may be a 2^{nd} position. Furthermore, as shown in FIG. 4A and FIG. 4B, the first, second, and third contact offer times 430a, 430b, 430c may be the same or different.

Once received, the agent device 120 is operable to output a contact offer time representation 450. As shown in FIGS. 4A and 4B, the agent device 120 may include a display device 440 that is operable to display a contact offer time representation 450, such as text, or graphics. In other embodiments, the agent device 120 includes speakers so that the representation 450 may be an audio signal.

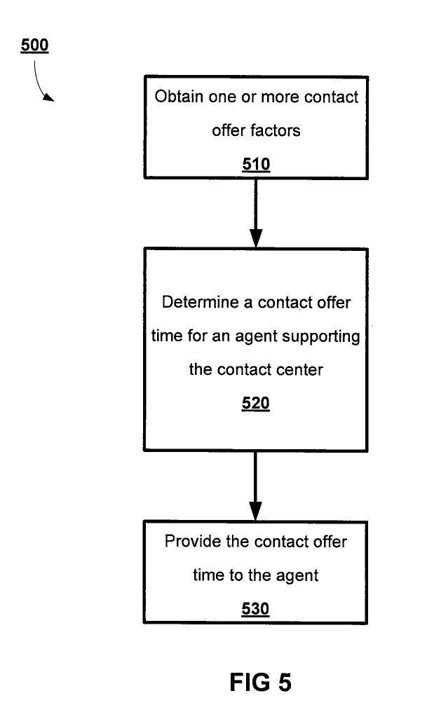

FIG. 5 illustrates one embodiment of a method 500 for assisting an agent supporting a contact center. The method 500 may include obtaining one or more contact offer factors 510, determining a contact offer time for the agent supporting the contact center 520, and providing the contact offer time to the agent 530. The acts shown in FIG. 5 may be performed in the order shown or a different order. The acts may be performed by a single device or multiple devices.

In act 510, a contact center obtains one or more contact offer factors. Obtaining one or more contact offer factors may include retrieving, receiving, requesting, or identifying the one or more contact offer factors. The contact offer factors may be obtained from an input device, memory, or both an input device and memory. The contact offer factors may be queue factors, contact factors, agent factors, contact center factors, and/or historical factors. Obtaining one or more contact offer factors may include processing data to determine one or more contact offer factors. For example, sets of data may be used to determine averages, maximums, or minimums.

In act 520, the contact center may determine a contact offer time for the agent supporting the contact center. The contact offer time may be determined based on the one or more contact offer factors. The contact offer time may define when the agent will receive a contact offer.

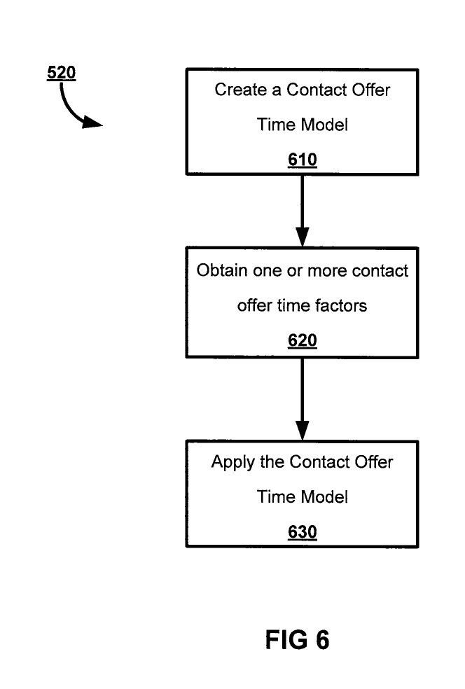

FIG. 6 illustrates one embodiment of a method 600 for determining a contact offer time. The method 600 includes creating a contact offer time model 610, obtaining one or more contact offer time factors 620, and applying the contact offer time model 630. The acts of FIG. 6 may be performed in the order shown or a different order. For example, act 620 may be performed prior to act 610.

In act 610, the contact center may create a contact offer time model. The model may be a contact offer time model. The model may be created using historical or current data about, related to, or associated with the contact, agent, or contact center or may be created based on expectations. The model may be used to determine a contact offer time, such that the contact center is operable to determine a contact offer time for an agent. In an alternative embodiment, creating the contact offer time model may include receiving the model from a remote device or memory.

In act 620, as discussed above, the contact center may obtain one or more contact offer factors. Act 620 may be performed in addition to or as a replacement of act 510. Obtaining the one or more contact offer factors may include retrieving, receiving, requesting, or identifying the one or more contact offer factors. The contact offer factors may be obtained from an input device, memory, or both an input device and memory. The contact offer factors may be queue factors, contact factors, agent factors, contact center factors, or historical factors. Obtaining one or more contact offer factors may include processing data to determine one or more contact offer factors. For example, sets of data may be used to determine averages, maximums, or minimums.

In act 630, the contact center may apply the contact offer time model. Applying the model may include inputting one or more contact offer factors into the contact offer model and outputting a contact offer time. The contact offer time may be a predication or estimation of when the agent will receive a contact offer.

Referring back to FIG. 5, in act 530, the contact center may provide the contact offer time to an agent, for example, via an agent device. Providing the contact offer time may include transmitting the contact offer time in a contact offer time message. Transmitting may include transmitting the contact offer time message to an agent device associated with the agent such that a contact offer time representation for that agent may be displayed on the agent device.

As shown in act 540, the method 500 may further include determining and transmitting a service wait time to a contact device. The service wait time may define an amount of time before the agent is available to communicate. The service wait time may be transmitted to the contact device in a service wait time message. The contact offer time message may be transmitted before, after, or both before and after the service wait time message is transmitted.

Various embodiments described herein can be used alone or in combination with one another. The foregoing detailed description has described only a few of the many possible implementations of the present invention. For this reason, this detailed description is intended by way of illustration, and not by way of limitation.

1. A method comprising:
obtaining one or more contact offer factors related to support of a contact center;
determining, using a processor, a contact offer time for an agent supporting a contact center based on the one or more contact offer factors, the contact offer time defining when the agent will receive a contact offer; and
outputting the contact offer time to the agent.

2. The method of claim 1, wherein the one or more contact offer factors includes information about a contact, a contact queue, an agent queue, the agent, or any combination thereof.

3. The method of claim 2, wherein determining the contact offer time includes inputting the one or more contact offer factors into a contact offer model to predict when the agent will receive a contact offer.

4. The method of claim 1, wherein providing the contact offer time to the agent includes transmitting the contact offer time to an agent device associated with the agent such that a contact offer time representation may be displayed on the agent device.

5. The method of claim 4, further comprising determining and transmitting a service wait time to a contact device, the service wait time defining an amount of time before the agent is available to communicate.

6. The method of claim 5, wherein transmitting the contact offer time includes transmitting a contact offer time message to the agent device and transmitting the service wait time include transmitting a service wait time message to the contact device, the agent device being different than the contact device and the contact offer time message being transmitted before, after, or both before and after the service wait time.

7. The method of claim 1, wherein the agent is an expert advisor that does not regularly handle communication received by the contact center.

8. A system comprising:
a processor configured to obtain one or more contact offer factors and determine a contact offer time for the agent supporting the contact center based on the one or more contact offer factors, the contact offer time defining when the agent will receive a contact offer; and
an output device coupled with the processor, the output device being operable to provide the contact offer time to the agent.

9. The system of claim 8, further comprising an input device and a memory, wherein the processor is operable to obtain the one or more contact offer factors from the input device, the memory, or both the input device and memory.

10. The system of claim 8, wherein the processor is operable to input the one or more contact offer factors into a contact offer model to predict when the agent will receive a contact offer.

11. The system of claim 8, wherein the output device is a network interface that is operable to transmit the contact offer time to an agent device associated with the agent, the network interface being coupled with the agent device via a network.

12. The system of claim 8, wherein the processor is operable to determine and transmit a service wait time to a contact device, the service wait time defining an amount of time before the agent is available to communicate.

13. The system of claim 8, wherein the agent is an expert advisor that does not regularly handle communication received by the contact center.

14. Logic encoded in one or more tangible media, the logic being executable by a processor and operable to:
obtain one or more contact offer factors;
determine a contact offer time for the agent supporting the contact center based on the one or more contact offer factors, the contact offer time defining when the agent will receive a contact offer; and
output the contact offer time to the agent.

15. The logic of claim 14, wherein the one or more contact offer factors includes information about a contact, a contact queue, an agent queue, the agent, or any combination thereof.

16. The logic of claim 15, wherein the logic is operable to input the one or more contact offer factors into a contact offer model to predict when the agent will receive a contact offer.

17. The logic of claim 14, wherein the logic is operable to transmit the contact offer time to an agent device associated with the agent such that a contact offer time representation may be displayed on the agent device.

18. The logic of claim 14, wherein the logic is operable to determine and transmit a service wait time to a contact device, the service wait time defining an amount of time before the agent is available to communicate.

19. The logic of claim 14, wherein the logic is operable to transmit a contact offer time message to the agent device and transmit a service wait time message to the contact device, the agent device being different than the contact device and the contact offer time message being transmitted before, after, or both before and after the service wait time.

20. The logic of claim 14, wherein the agent is an expert advisor that does not regularly handle communication received by the contact center.
